(19) United States
(12) Patent Application Publication
(10) Pub. No.: US 2021/0370570 A1
(43) Pub. Date: Dec. 2, 2021

(54) DEVICE FOR BLOWING AND STRETCHING PLASTIC PACKAGING FILM AND METHOD THEREOF

(71) Applicant: TZU-CHIN HUNG, TAIPEI CITY (TW)

(72) Inventor: TZU-CHIN HUNG, TAIPEI CITY (TW)

(21) Appl. No.: 17/404,213

(22) Filed: Aug. 17, 2021

Related U.S. Application Data
(62) Division of application No. 15/834,526, filed on Dec. 7, 2017.

(30) Foreign Application Priority Data
Nov. 17, 2017 (TW) 106139992

(51) Int. Cl. B29C 48/00; B29C 55/28; B29C 49/28; B65D 65/38; B29C 49/00

(52) U.S. Cl. CPC B29C 48/0017; B29C 55/28; B29C 49/28; B29L 2007/008; B29C 49/0005; B29C 48/0018; B65D 65/38

(57) ABSTRACT

A device and method for blowing and stretching a plastic film are provided. A first blow-expanding mechanism subjects a primitive plastic film made of PVC, PLA, or PET to extrusion at a temperature of 140° C.-180° C. and primary blow-expansion to form a volume in which the primitive plastic film has a lateral opening ratio of 1:1. Front-stage press rollers and middle-stage press rollers then subject the primitive plastic film to primary longitudinal press-flattening and pull-stretching, followed by heating and blow-expanding by the second blow-expansion mechanism at a temperature of 160° C.-220° C. and a pressure of 1.1-1.6 atm to achieve a volume in which the primitive plastic film has lateral opening ratio of at least 2:1, further followed by reduction of temperature to a temperature of 10° C.-20° C. for shape fixing to form a shaped plastic film. Finally, rear-stage press rollers subject the shaped plastic film to secondary longitudinal press-flattening and pull-stretching.

### BACKGROUND OF THE INVENTION

### 1. Field of the Invention

The present invention relates to a device and a method that are applicable to thermal shrinkage plastic packaging films of various materials and involve at least two homogeneous blow-expansion operations conducted in a lateral direction and also includes compress-flattening and pull-stretching operation in a longitudinal direction through rotational speed differences of multiple press rollers of front-stage, middle-stage, and rear-stage so as to form, generally through blowing and stretching, plastic packaging film that is homogeneous in respect of stress in both the lateral and longitudinal directions.

### 2. The Related Arts

Thermal shrinkage plastic packaging films have been widely used in applications of thermal shrinkage packages for packaged products, particularly outer packages for consumer products, such as foods, beverages, optical disks, and books, and industrial products. Consumers and manufacturers are now placing ever severer demand for quality of package formed with packaging films and aesthetics of outside looking for products. For example, sealed packages of foodstuffs and meal boxes are required to be neat and good-looking. However, during a process of production, the conventional thermal shrinkage plastic films were only subjected to stretching through mechanical pulling and this leads to stretching stress, and also quality, of the films inhomogeneous in lateral and longitudinal directions and may readily cause wrinkling and curving on the surface of the thermal shrinkage plastic film after the film that is wrapped around a product and subjected to sealing and thermal shrinkage. This would severely affects the quality and aesthetics of the sealed package formed with the thermal shrinkage plastic film and would also lower the value of the product and reduce consumers' desire of purchasing the product. This is apparently an important issue to be resolved for the thermal shrinkage plastic films.

Prior patent documents in this field are known. An example is Japanese Laid-Open Publication No. 1989-127317, which discloses a film that is formed by pulling and stretching of a non-stretching film made of crystalline polyester obtained through melting and extrusion, of which thermal shrinkage rate below 70° C. in either longitudinal direction or lateral direction is at least 10% and is characterized in that for thermal shrinkage conducted in orthogonal direction under 125° C.±5%, the amount of heat generated for cold crystallization is at least 17.0 mJ/mg (see claim 1 of the patent document). In other words, such a thermal shrinkage film must be made of crystalline polyester, and further, stretching is only applicable to the film in one direction. This leads to the same inhomogeneity issues in respect of stretching stress and quality in the lateral direction or the longitudinal direction of the known thermal shrinkage plastic film discussed above and would readily causes severe situation of wrinkling and curving on the surface of the thermal shrinkage package film after it is used to package a product and subjected to sealing and thermal shrinkage operations so as to greatly affect the quality and aesthetic looking of a sealed product packaged with the thermal shrinkage plastic film. Further, in view of the constraint that the plastic film of such a prior patent document must be made of crystalline polyester, such a technique is only applicable to thermal shrinkage films made of one single type of material of polyethylene terephthalate (PET) and this would limit the range of application of such a film.

In addition, Japanese Patent Gazette Publication No. 4411556 discloses a thermal shrinkage polyester-based film and a manufacturing method thereof, which provides a technique involving a thermal shrinkage polyester film having a major, longitudinal shrinkage direction and a manufacturing method thereof, in which polyethylene terephthalate is the primary component, one or more monomeric components that can be made in amorphous form, total polyester resin being of a content of greater than 10% mole, is formed an elongate strip form having a fixed width. The chemical components of the thermal shrinkage polyester-based film are complicated (as described in paragraphs [0018]-[0024] of the specification of the prior art patent document) in order to provide improved characteristics concerning film stretch ability and thermal shrinkage rate. This, however, increases the manufacturing cost of the thermal shrinkage polyester-based film and imposes constraint on the application to only the thermal shrinkage plastic film made of one single type of material of polyethylene terephthalate. This apparently limits the range of application and provides no economic benefit for industrial use.

In addition, Japanese Laid-Open Patent Publication No. 2017-74750 discloses a dual-axis stretched polyethylene terephthalate based film and a manufacturing method thereof, which similarly disclose a film made of a primary component of polyethylene terephthalate with complicated chemical composition of the film, and viscosity coefficient being controlled As described in paragraphs [0017]-[0020] of the publication document of this prior art, mechanical dual-axis stretching operation is applicable to the film in the longitudinal direction and the lateral direction. The thermal shrinkage film of this patent document is similarly only applicable to thermal shrinkage film made of one single type of material of polyethylene terephthalate and is not applicable to thermal shrinkage films made of other materials, such as polyvinyl chloride (PVC) and polylactic acid (PLA). This limits the range of industrial application of the thermal shrinkage film and also lowers economic benefit thereof. In addition, the thermal shrinkage film of the patent document has an even complicated chemical composition. This increases the manufacturing cost thereof. A stretching operation of the thermal shrinkage film in longitudinal direction and lateral direction can only be applied to a sheet form of thermal shrinkage film and cannot be used in a tubular thermal shrinkage film. In addition, distribution and variation of crystalline grains in the entirety of thermal shrinkage film of the patent document must be carefully watched so that the stretching operation of the film in the longitudinal direction and the lateral direction is difficult and the quality of the thermal shrinkage film is hard to control when subjected to dual-axis stretching. In other words, the thermal shrinkage film of the patent document may not achieve a condition of complete homogeneity in stretching in the longitudinal direction and the lateral direction, and would similarly suffer inhomogeneity quality and stress in stretching as those discussed above with reference to conventional thermal shrinkage film and may readily cause wrinkling and curving on the surface of the thermal shrinkage plastic film after the film that is wrapped around a product and subjected to sealing and thermal shrinkage. This would severely affect the quality and aesthetics of the sealed package formed with the thermal shrinkage plastic film.

### SUMMARY OF THE INVENTION

The primary objective of the present invention is to provide a device and a method for blowing and stretching plastic packaging film in order to eliminate the issues that the conventional thermal shrinkage film or the thermal shrinkage film available from the prior patent documents suffer inhomogeneity of stress and quality of mechanical stretching in a lateral direction and a longitudinal direction and may readily cause wrinkling and curving on a surface of the thermal shrinkage plastic film that greatly affect quality and aesthetics of a sealed product packaged with the thermal shrinkage plastic film, after the film is wrapped around the product and subjected to sealing and thermal shrinkage and are only applicable to thermal shrinkage film product made of one single type of material of PET thereby greatly limiting the range of industrial use of such a thermal shrinkage film and lowering economic benefit thereof.

Thus, the present invention provides a plastic film blowing and stretching device, which comprises:

at least one first blow-expanding mechanism, which is operable to subject a primitive plastic film made of a material of one of PVC, PLA, and PET to extrusion at a temperature of 140° C.-180° C. for primary blow-expanding so as to achieve a volume in which the primitive plastic film has a lateral opening ratio of 1:1;

at least one pair of front-stage press rollers and middle-stage press rollers, which are sequentially operable to subject the primitive plastic film that has been subjected to primary blow-expanding by the first blow-expanding mechanism to primary longitudinal press-flattening and pull-stretching;

at least one second blow-expansion mechanism, which is operable to subject the primitive plastic film that has been subjected to the primary press-flattening and pull-stretching to heating and blow-expanding at a temperature of 160° C.-220° C. and a pressure of 1.1-1.6 atm to achieve a volume in which the primitive plastic film has a lateral opening ratio of at least 2:1 so as to form as a shaped plastic film; and

at least one pair of rear-stage press rollers, which is operable to subject the shaped plastic film that has been subjected to blow-expanding by the second blow-expansion mechanism to secondary longitudinal press-flattening and pull-stretching so as to supply a plastic packaging film product having uniform blow-expansion and pull-stretching stress and quality in both lateral direction and longitudinal direction.

Further, in the above-described plastic film blowing and stretching device of the present invention, the first blow-expanding mechanism comprises:

at least one extrusion machine, which conducts initial extrusion of the primitive plastic film;

at least one mold head, which is arranged above the extrusion machine to serve as a mold for initial molding and out-feeding of the primitive plastic film; and

at least one air ring, which is arranged above the mold head to conduct the primary blow-expanding on the primitive plastic film that has been molded and out-fed from the mold head to achieve a volume in which the primitive plastic film has a lateral opening ratio of 1:1.

In the above-described plastic film blowing and stretching device of the present invention, the air ring of the first blow-expanding mechanism is connected to an air blower to provide an air supply source for the primary blow-expanding of the primitive plastic film to the volume in which the primitive plastic film has a lateral opening ratio of 1:1.

In the above-described plastic film blowing and stretching device of the present invention, at least one pair of first press boards are arranged under the front-stage press rollers to subject the primitive plastic film that has been subjected to blow-expanding by the first blow-expanding mechanism to the primary longitudinal press-flattening and supplying into between the two front-stage press rollers.

In the above-described plastic film blowing and stretching device of the present invention, the second blow-expansion mechanism comprises:

at least one heating device, which is arranged at a lower side of the second blow-expansion mechanism and comprises at least one heating-extension water tank and a heater, the heating-extension water tank receiving and holding therein water and accommodating the heater and the middle-stage press rollers arranged therein so that the heater is operable to heat the water to have the primitive plastic film that has been subjected to primary press-flattening and pull-stretching by the middle-stage press rollers to heating to a temperature of 160° C.-220° C.;

at least one annular water tank, which is arranged above the heating device and is filled, in an interior thereof, with water of a temperature of 10° C.-20° C. to allow for shaping of the primitive plastic film that has been heated by the heating device; and

at least one movable air charging device, which is arranged above the annular water tank and comprises at least one movable air charging nozzle and an air charger, the movable air charging nozzle being connected to the air charger, the movable air charging nozzle extendable into an interior of the primitive plastic film that has been subjected to shaping by the annular water tank in order to supply a pressure of 1.1-1.6 atm into the interior of the primitive plastic film to subject the primitive plastic film that has been subjected to primary longitudinal press-flattening and pull-stretching to heating and blow-expanding to achieve a volume in which the primitive plastic film has a lateral opening ratio of at least 2:1 to shape and out feed a shaped plastic film.

In the above-described plastic film blowing and stretching device of the present invention, at least one pair of the second press boards are arranged under the rear-stage press rollers to subject the shaped plastic film that has been subjected to blow-expanding by the second blow-expansion mechanism to secondary longitudinal press-flattening.

In the above-described plastic film blowing and stretching device of the present invention, the second blow-expansion mechanism comprises:

at least one heating-extension oven, which is arranged at a location at an upper side of the second blow-expansion mechanism and below the middle-stage press rollers so that the heating-extension oven subjects the primitive plastic film that has been subjected to the primary press-flattening and pull-stretching by the middle-stage press rollers to heating to a temperature of 160° C.-220° C.;

at least one annular water tank, which is arranged below the heating-extension oven and is filled, in an interior thereof, with water having a temperature of 10° C.-20° C. for shaping the primitive plastic film that has been heated by the heating-extension oven; and

at least one movable air charging device, which is arranged below the annular water tank and comprises at least one movable air charging nozzle and an air charger, the movable air charging nozzle being connected to the air charger, the movable air charging nozzle being extendable into an interior of the primitive plastic film that has been shaped by the annular water tank in order to supply a pressure of 1.1-1.6 atm into the interior of the primitive plastic film to subject the primitive plastic film that has been subjected to primary longitudinal press-flattening and pull-stretching to heating and blow-expanding to achieve a volume in which the primitive plastic film has a lateral opening ratio of at least 2:1 to shape and out feed a shaped plastic film.

In the above-described plastic film blowing and stretching device of the present invention, at least one guide roller is arranged between the front-stage press rollers and the middle-stage press rollers for guiding the primitive plastic film.

In the above-described plastic film blowing and stretching device of the present invention, at least one pair of press boards each of which is configured in the form of rollers are provided above the rear-stage press rollers to subject the shaped plastic film that has been subjected to blow-expanding by the second blow-expansion mechanism to secondary longitudinal press-flattening.

In the above-described plastic film blowing and stretching device of the present invention, a rotational speed difference among the front-stage press rollers, the middle-stage press rollers, and the rear-stage press rollers is between 30%-80%.

The present invention provides a method for blowing and stretching a plastic packaging film, which comprises the following steps:

(a) a step of initial molding of primitive plastic film through extrusion, in which a first blow-expanding mechanism extrudes a primitive plastic film made of a material selected from one of PVC, PLA, and PET at a temperature of 140° C.-180° C. for initial molding;

(b) a step of primary blow-expansion processing of primitive plastic film in lateral direction, in which the primitive plastic film that is extruded and initially molded in Step (a) is subjected to primary blow-expansion processing with a first blow-expanding mechanism so that the primitive plastic film is blown and expanded in the lateral direction to a volume of which an opening ratio is 1:1;

(c) a step of primary press-flattening and pull-stretching processing of primitive plastic film in longitudinal direction, in which the primitive plastic film that has been subjected to the primary blow-expansion processing in Step (b) is subjected to primary press-flattening and pull-stretching processing of the primitive plastic film in a longitudinal direction by at least one pair of front-stage press rollers and middle-stage press rollers;

(d) a step of secondary blow-expansion processing of primitive plastic film in lateral direction, in which the primitive plastic film that has been subjected to the primary press-flattening and pull-stretching in Step (c) is processed with a second blow-expansion mechanism to subject the primitive plastic film that has been subjected to primary longitudinal press-flattening and pull-stretching to heating and secondary blow-expanding at a temperature of 160° C.-220° C. and a pressure of 1.1-1.6 atm to achieve a volume in which the primitive plastic film has an opening ratio of at least 2:1 in the lateral direction for being shaped and feeding out as a shaped plastic film;

(e) a step of secondary press-flattening and pull-stretching processing of shaped plastic film in longitudinal direction, in which the shaped plastic film that has been subjected to secondary blow-expanding in Step (d) is processed with at least one pair of rear-stage press rollers to subject the shaped plastic film to secondary press-flattening and pull-stretching in the longitudinal direction; and

(f) a step of out-feeding of plastic packaging film product, in which the shaped plastic film that has been subjected to secondary press-flattening and pull-stretching in Step (e) becomes and is fed out as a plastic packaging film product that has been blown and expanded, and pulled and stretched to show homogeneous stress and quality in both lateral direction and longitudinal direction.

In the above-described method for blowing and stretching a plastic packaging film according to the present invention, the primitive plastic film of

Step (a) is made of a material of PVC and the second blow-expansion mechanism of Step (d) carries out heating and blow-expanding of the primitive plastic film that has been subjected to primary longitudinal press-flattening and pull-stretching at a temperature of 165° C.-195° C. and a pressure of 1.1-1.6 atm to achieve a volume in which the primitive plastic film has a lateral opening ratio of at least 2:1 for shaping and out-feeding as a shaped plastic film.

In the above-described method for blowing and stretching a plastic packaging film according to the present invention, the primitive plastic film of Step (a) is made of a material of PLA and the second blow-expansion mechanism of Step (d) carries out heating and blow-expanding of the primitive plastic film that has been subjected to primary longitudinal press-flattening and pull-stretching at a temperature of 160° C.-185° C. and a pressure of 1.1-1.6 atm to achieve a volume in which the primitive plastic film has a lateral opening ratio of at least 2:1 for shaping and out-feeding as a shaped plastic film.

In the above-described method for blowing and stretching a plastic packaging film according to the present invention, the primitive plastic film of Step (a) is made of a material of PET and the second blow-expansion mechanism of Step (d) carries out heating and blow-expanding of the primitive plastic film that has been subjected to primary longitudinal press-flattening and pull-stretching at a temperature of 180° C.-220° C. and a pressure of 1.1-1.6 atm to achieve a volume in which the primitive plastic film has a lateral opening ratio of at least 2:1 for shaping and out-feeding as a shaped plastic film.

In the above-described method for blowing and stretching a plastic packaging film according to the present invention, a rotational speed among the front-stage press rollers and the middle-stage press rollers of step (c) and the rear-stage press rollers of step (e) is between 30%-80%.

In the above-described method for blowing and stretching a plastic packaging film according to the present invention, in Step (d), the second blow-expansion mechanism carries out heating of the primitive plastic film at a temperature of 160° C.-220° C. and then reducing the temperature of 10° C.-20° C. to achieve shape fixing of the primitive plastic film, followed by the secondary blow-expanding by supplying a pressure of 1.1-1.6 atm into the primitive plastic film.

The efficacy of the device and method for blowing and stretching a plastic packaging film according to the present invention is that the first blow-expanding mechanism, the front-stage press rollers and the middle-stage press rollers, the second blow-expansion mechanism and the rear-stage press rollers are operable to respectively subject the primitive plastic film to primary blow-expansion to achieve a volume in which the primitive plastic film has a lateral opening ratio of 1:1, primary longitudinal press-flattening and pull-stretching of the primitive plastic film, secondary lateral blow-expansion to achieve a volume in which the primitive plastic film has a lateral opening ratio of at least 2:1, and secondary longitudinal press-flattening and pull-stretching of the shaped plastic film, to finally make the plastic packaging film product is uniform of stress and quality through blow-expanding and pull-stretching in both lateral direction and longitudinal direction. Further, the manufacturing cost of the plastic packaging film can be greatly saved without changing the chemical composition or molecular structure of the primitive plastic film. Further, the thermal shrinkage packaging film of the present invention can be made of any one of PVC, PLA, and PET so as to greatly improve the range of industrial application and economic benefit thereof and to completely eliminate the issues that the conventional thermal shrinkage film or the thermal shrinkage film available from the prior patent documents suffer inhomogeneity of stress and quality of mechanical stretching in a lateral direction and a longitudinal direction and may readily cause wrinkling and curving on a surface of the thermal shrinkage plastic film that greatly affect quality and aesthetics of a sealed product packaged with the thermal shrinkage plastic film, after the film is wrapped around the product and subjected to sealing and thermal shrinkage and are only applicable to thermal shrinkage film product made of one single type of material of PET thereby greatly limiting the range of industrial use of such a thermal shrinkage film and lowering economic benefit thereof.

### BRIEF DESCRIPTION OF THE DRAWINGS

The present invention will be apparent to those skilled in the art by reading the following description of preferred embodiments thereof, with reference to the attached drawings, wherein:

FIG. 1 is a schematic view showing a structure of a device for blowing and stretching a plastic packaging film according to a first embodiment of the present invention;

FIG. 2 is a schematic view illustrating an operation of the device for blowing and stretching a plastic packaging film according to the first embodiment of the present invention;

FIG. 3 is a schematic view showing a structure of a device for blowing and stretching a plastic packaging film according to a second embodiment of the present invention;

FIG. 4 is a schematic view illustrating an operation of the device for blowing and stretching a plastic packaging film according to the second embodiment of the present invention; and

FIG. 5 is a flow chart illustrating a method for blowing and stretching a plastic packaging film according to the present invention.

### DETAILED DESCRIPTION OF THE PREFERRED EMBODIMENTS

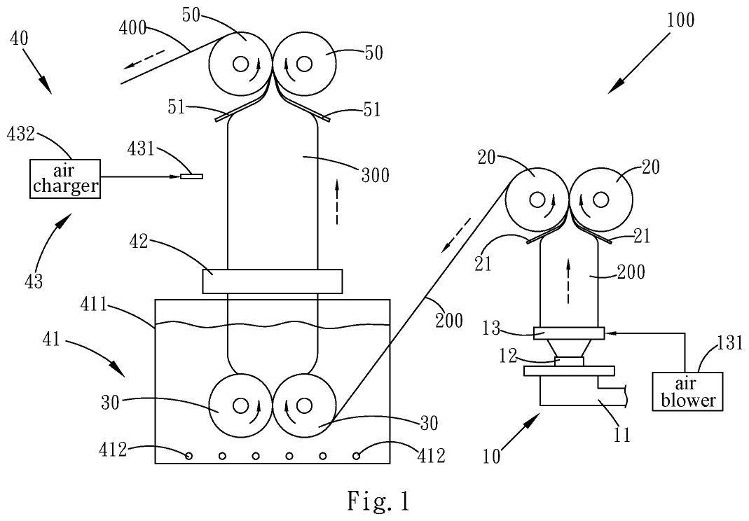

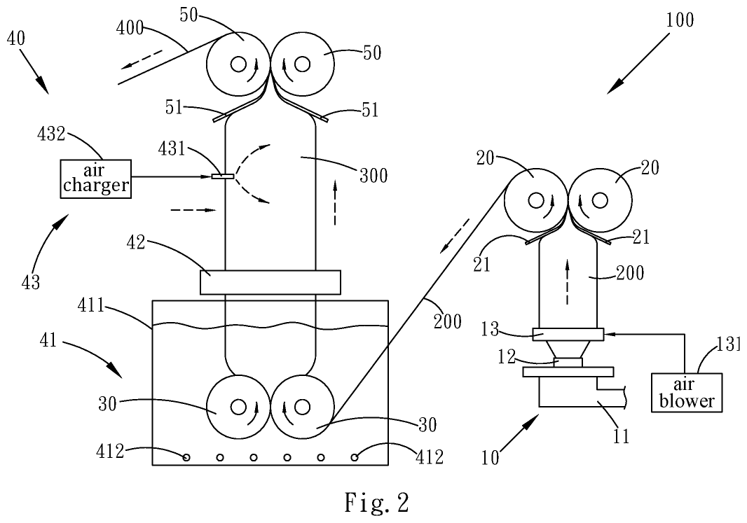

Referring to FIGS. 1 and 2, the present invention provides a device for blowing and stretching a packaging film, which is generally designated at 100 and comprises, in a first embodiment thereof, comprises at least one first blow-expanding mechanism 10. The first blow-expanding mechanism 10 is operable to extrude a primitive plastic film 200 made of one of materials including PVC, PLA, and PET at a temperature of 140° C.-180° C. for primary blow-expansion thereof to a volume in which the primitive plastic film 200 has a lateral opening ratio of 1:1. The first blow-expanding mechanism 10 is not limited to any specific type, and in the present invention an example is provided, comprising at least one extrusion machine 11, at least one mold head 12, and at least one air ring 13. The extrusion machine 11 is operable for primary extrusion of the primitive plastic film 200. The mold head 12 is arranged above the extrusion machine 11 to serve as a mold for primary molding of the primitive plastic film 200. The air ring 13 is arranged above the mold head 12 for primary blow-expansion of the primitive plastic film 200 molded by and fed from the mold head 12 to a volume in which the primitive plastic film 200 has a lateral opening ratio of 1:1. The air ring 13 is connected to an air blower 131, which provides an air supply source for the primary blow-expansion of the primitive plastic film 200 to the volume in which the primitive plastic film 200 has a lateral opening ratio of 1:1.

At least one pair of front-stage press rollers 20 and at least one pair of middle-stage press rollers 30 are provided, wherein at least one pair of first press boards 21 are provided below the front-stage press rollers 20 to subject the primitive plastic film 200 that has been blown and expanded by the first blow-expanding mechanism 10 to primary longitudinal press-flattening and feeding into between the two front-stage press rollers 20 so that the front-stage press rollers 20 and the middle-stage press rollers 30 subject the primitive plastic film 20 that has been blown and expanded by the first blow-expanding mechanism 10 to primary longitudinal press-flattening and pull-stretching in sequence, wherein a rotational speed difference between the front-stage press rollers 20 and the middle-stage press rollers 30 is between 30%-80% so as to provide forces for conducting the primary longitudinal press-flattening and pull-stretching of the primitive plastic film 200. The front-stage press rollers 20 and the middle-stage press rollers 30 are not limited to any specific way of driving and rotation and an example provided in this invention includes being driven to rotate by a motor (not shown).

At least one second blow-expansion mechanism 40 is operable to subject the primitive plastic film 200 that has been subjected to primary press-flattening and pull-stretching by the front-stage press rollers 20 and the middle-stage press rollers 30 to heating and blow-expanding at a temperature of 160° C.-220° C. and a pressure of 1.1-1.6 atm to a volume in which the primitive plastic film 200 has a lateral opening ratio of at least 2:1 to form a shaped plastic film 300. Further, for different materials, including PVC, PLA, and PET, that make the primitive plastic film 200, the ranges of heating temperature are different, wherein for a primitive plastic film 200 made of a PVC material, the range of heating temperature covers 165° C.-195° C.; for a primitive plastic film 200 made of a PLA material, the range of heating temperature covers 180° C.-220° C.; and for a primitive plastic film 200 made of a PET material, the range of heating temperature covers 160° C.-185° C.

The second blow-expansion mechanism 40 described above is not limited to any specific type and in the first embodiment of the present invention, an example is provided, comprising at least one heating device 41, at least one annular water tank 42, and at least one movable air charging device 43, wherein the heating device 41 is arranged at a lower side of the second blow-expansion mechanism 40 and comprises at least one heating-extension water tank 411 and a heater 412. The heating-extension water tank 411 receives and holds water and also receives the heater 412 and the middle-stage press rollers 30 arranged therein so as to heat, through heating water with the heater 412, the primitive plastic film 200 that has been subjected to first press-flattening and pull-stretching by and fed through the middle-stage press rollers 30 to a temperature of 160° C.-220° C.

The annular water tank 42 is arranged above the heating device 41 and is filled therein with water having a temperature of 10° C.-20° C. in order to achieve temperature reduction for the primitive plastic film 200 that has been subjected to heating with the heating device 41 to a temperature of 10° C.-20° C. for shape fixing.

The movable air charging device 43 is arranged above the annular water tank 42 and comprises at least one movable air charging nozzle 431 and an air charger 432. The movable air charging nozzle 431 is connected to the air charger 432. The movable air charging nozzle 431 is operable to penetrate into an interior of the primitive plastic film 200 (see FIG. 2) that has been shaped as passing through the annular water tank 42 in order to supply a pressure of 1.1-1.6 atm into the interior of the primitive plastic film 200 to subject the primitive plastic film 200 that has been subjected to primary longitudinal press-flattening and pull-stretching to heating and blow-expanding to a volume in which the primitive plastic film 200 has a lateral opening ratio of at least 2:1 to shape and feed out as a shaped plastic film 300.

At least one pair of rear-stage press rollers 50 are provided, with at least one pair of second press boards 51 arranged there below to carry out a secondary longitudinal press-flattening operation on the shaped plastic film 300 that has been blown and expanded by the second blow-expansion mechanism 40 to subsequently feed into between the two rear-stage press rollers 50 to allow the rear-stage press rollers 50 to subject the shaped plastic film 300 that has been subjected to blowing and expanding by the second blow-expansion mechanism 40 to the secondary longitudinal press-flattening and pull-stretching so as to feed out a plastic packaging film product 400, which has uniform extension stress of blowing-expanding and pulling-stretching in both lateral and longitudinal directions and quality. The rear-stage press rollers 50 are not limited to any specific way of driving to rotate and in this invention, an example is provided as being driven to rotate by a motor (not shown). Further, a rotational speed difference between the rear-stage press rollers 50 and the middle-stage press rollers 30 is between 30%-80% so as to provide forces for conducting the secondary longitudinal press-flattening and pull-stretching.

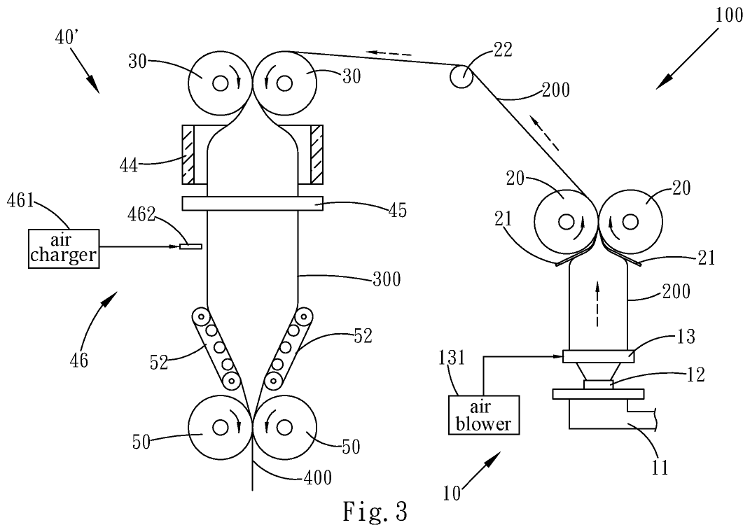

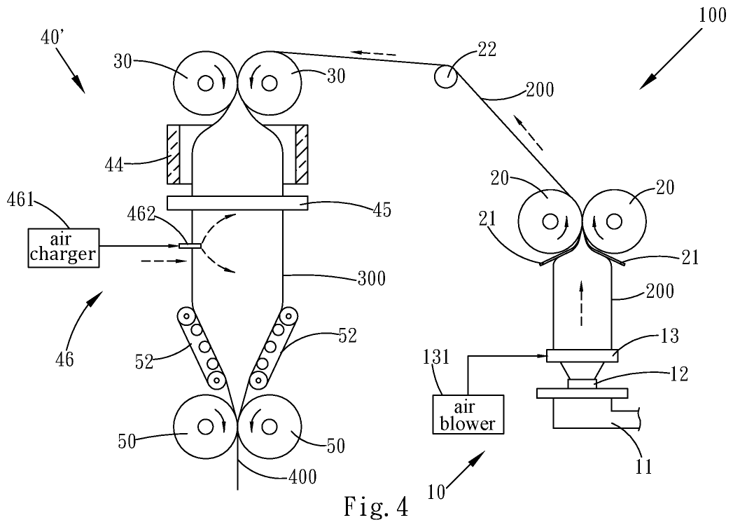

Referring to FIGS. 3 and 4, a device for blowing and stretching of a plastic package film according to a second embodiment of the present invention, also designated at 100, is shown, wherein at least one guide roller 22 is arranged between the front-stage press rollers 20 and the middle-stage press rollers 30 to guide the primitive plastic film 200. The second blow-expansion mechanism 40′ is provided, as an example, comprising at least one heating-extension oven 44, at least one annular water tank 45, and at least one movable air charging device 46, wherein the heating-extension oven 44 is arranged at a location that is at an upper side of the second blow-expansion mechanism 40′ and below the middle-stage press rollers 30 in order to allow the heating-extension oven 44 to heat the primitive plastic film 200 that has been subjected to primary press-flattening and pull-stretching by the middle-stage press rollers 30 to a temperature of 160° C.-220° C. The heating-extension oven 44 is not limited to any specific type and an electric heating oven is taken as an example in this invention.

The annular water tank 45 is arranged under the heating-extension oven 44 and is filled, in the interior thereof, with water of a temperature of 10° C.-20° C. in order to achieve temperature reduction of the primitive plastic film 200 that has been heated by the heating-extension oven 44 to a temperature of 10° C.-20° C. for shape fixing.

The movable air charging device 46 is arranged below the annular water tank 45 and comprises at least one movable air charging nozzle 462 and an air charger 461. The movable air charging nozzle 462 is connected to the air charger 461. The movable air charging nozzle 462 is operable to penetrate into an interior of the primitive plastic film 200 (see FIG. 4) that has been shaped as passing through the annular water tank 45 in order to supply a pressure of 1.1-1.6 atm into the interior of the primitive plastic film 200 to subject the primitive plastic film 200 that has been subjected to primary longitudinal press-flattening and pull-stretching to heating and blow-expanding to a volume in which the primitive plastic film 200 has a lateral opening ratio of at least 2:1 to shape and feed out as a shaped plastic film 300.

The rear-stage press rollers 50 are provided, on an upper side thereof, with at least one pair of press boards 52 each configured in the form of rollers to carry out a secondary longitudinal press-flattening operation on the shaped plastic film 300 that has been blown and expanded by the second blow-expansion mechanism 40′ to subsequently feed into between the two rear-stage press rollers 50 to allow the rear-stage press rollers 50 to subject the shaped plastic film 300 that has been blown and expanded by the second blow-expansion mechanism 40′ to the secondary longitudinal press-flattening and pull-stretching so as to feed out a plastic packaging film product 400, which has uniform extension stress of blowing-expanding and pulling-stretching in both lateral and longitudinal directions and quality.

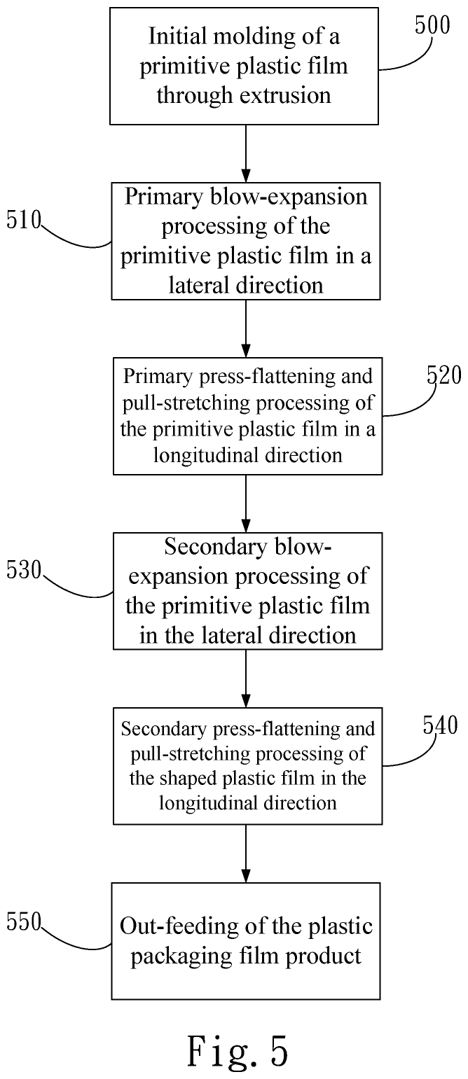

Referring to FIG. 5, FIG. 5 is a flow chart illustrating a method for blowing and stretching a plastic packaging film according to the present invention, comprising Step 500-550, wherein:

(500) Initial molding of a primitive plastic film through extrusion, in which a first blow-expanding mechanism 10 extrudes a primitive plastic film 200 made of a material selected from one of PVC, PLA, and PET at a temperature of 140° C.-180° C. for initial molding;

(510) Primary blow-expansion processing of the primitive plastic film in a lateral direction, in which the primitive plastic film 200 that is extruded and initially molded in Step (500) is subjected to primary blow-expansion processing with the first blow-expanding mechanism 10 so that the primitive plastic film 200 is blown and expanded in the lateral direction to a volume of which an opening ratio is 1:1;

(520) Primary press-flattening and pull-stretching processing of the primitive plastic film in a longitudinal direction, in which the primitive plastic film 200 that has been subjected to the primary blow-expansion processing in Step (510) is subjected to primary press-flattening and pull-stretching processing of the primitive plastic film 200 in a longitudinal direction by the front-stage press rollers 20 and the middle-stage press rollers 30;

(530) Secondary blow-expansion processing of the primitive plastic film in the lateral direction, in which the primitive plastic film 200 that has been subjected to the primary press-flattening and pull-stretching in Step (520) is processed with the second blow-expansion mechanism 40, 40′ to subject the primitive plastic film 200 that has been subjected to primary longitudinal press-flattening and pull-stretching to heating and secondary blow-expanding at a temperature of 160° C.-220° C. and a pressure of 1.1-1.6 atm to achieve a volume in which the primitive plastic film 200 has an opening ratio of at least 2:1 in the lateral direction for being shaped and feeding out as a shaped plastic film 300;

(540) Secondary press-flattening and pull-stretching processing of the shaped plastic film in the longitudinal direction, in which the shaped plastic film 300 that has been subjected to secondary blow-expanding in Step (530) is processed with the rear-stage press rollers 50 to subject the shaped plastic film 300 to secondary press-flattening and pull-stretching in the longitudinal direction; and

(550) Out-feeding of the plastic packaging film product, in which the shaped plastic film 300 that has been subjected to secondary press-flattening and pull-stretching in Step (540) becomes and is fed out as a plastic packaging film product 400 that has been blown and expanded, and pulled and stretched to show homogeneous stress and quality in both lateral direction and longitudinal direction.

Similarly, in the above-described method for blowing and stretching a plastic packaging film according to the present invention, the primitive plastic film 200 involved in Step (500) is made of a material selected from PVC, PLA, and PET and the range of heating temperature of the second blow-expansion mechanism 40, 40′ used in Step (530) is set such that for a primitive plastic film 200 made of a PVC material, the range of heating temperature covers 165° C.-195° C.; for a primitive plastic film 200 made of a PLA material, the range of heating temperature covers 180° C.-220° C.; and for primitive plastic film 200 made of a PET material, the range of heating temperature covers 160° C.-185° C.

In the above-described method for blowing and stretching a plastic packaging film according to the present invention, a rotational speed difference between the middle-stage press rollers 30 and the front-stage press rollers 20 in Step (520) and the rear-stage press rollers 50 in Step (540) are each between 30%-80% so as to provide forces for conducting the primary press-flattening and pull-stretching of the primitive plastic film 200 and the secondary press-flattening and pull-stretching of the shaped plastic film 300.

In the above-described method for blowing and stretching a plastic packaging film according to the present invention, in Step (530), the second blow-expansion mechanism 40, 40′ conducts heating of the primitive plastic film 200 at a temperature 160° C.-220° C. and then the annular water tank 42 or the annular water tank 45 conducts reduction of temperature by 10° C.-20° C. so as to complete shape fixing of the primitive plastic film 200.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A plastic film blowing and stretching device, comprising:
at least one first blow-expanding mechanism, which comprises at least one extrusion machine, at least one mold head, and at least one air ring, wherein the extrusion machine of the first blow-expanding mechanism is operable to subject a primitive plastic film made of a material of one of polyvinyl chloride (PVC), polylactic acid (PLA), and polyethylene terephthalate (PET) to initial extrusion at a temperature of 140° C.-180° C., the air ring being arranged above the mold head, the mold head being arranged above the extrusion machine, for subjecting the primitive plastic film to primary blow-expanding so as to achieve a volume in which the primitive plastic film has a lateral opening ratio of 1:1;
at least one pair of front-stage press rollers and middle-stage press rollers, which are sequentially operable to subject the primitive plastic film that has been subjected to primary blow-expanding by the first blow-expanding mechanism to primary longitudinal press-flattening and pull-stretching;
at least one second blow-expansion mechanism, which comprises at least one heating-extension oven, at least one annular water tank, and at least one movable air charging device, wherein the heating-extension oven is arranged at a location at an upper side of the second blow-expansion mechanism and below the middle-stage press rollers, so that the heating-extension oven subjects the primitive plastic film that has been subjected to the primary press-flattening and pull-stretching to heating to a temperature of 160° C.-220° C., the annular water tank being arranged above the heating-extension oven and filled, in an interior thereof, with water having a temperature of 10° C.-20° C. for shaping the primitive plastic film that has been heated by the heating-extension oven, the movable air charging device being arranged above the annular water tank and comprising at least one movable air charging nozzle and an air charger, the movable air charging nozzle being connected to the air charger, the movable air charging nozzle being extendable into an interior of the primitive plastic film that has been shaped by the annular water tank in order to supply a pressure of 1.1-1.6 atm into the interior of the primitive plastic film to subject the primitive plastic film that has been subjected to primary longitudinal press-flattening and pull-stretching and has been heated and shaped by the heat-extension oven and the annular water tank to heating and blow-expanding to achieve a volume in which the primitive plastic film has a lateral opening ratio of at least 2:1 so as to form a shaped plastic film; and
at least one pair of rear-stage press rollers, wherein a rotational speed difference of thee rear-stage press rollers and the front-stage and middle-stage press rollers is between 30%-80%, and the rear-stage press roller are operable to subject the shaped plastic film that has been subjected to blow-expanding by the second blow-expansion mechanism to secondary longitudinal press-flattening and pull-stretching so as to supply a plastic packaging film product having uniform blow-expansion and pull-stretching stress and quality in both lateral direction and longitudinal direction.

2. A method for blowing and stretching a plastic packaging film, comprising the following steps:
(a) a step of initial molding of primitive plastic film through extrusion, in which a first blow-expanding mechanism extrudes a primitive plastic film made of a material selected from one of PVC, PLA, and PET at a temperature of 140° C.-180° C. for initial molding;
(b) a step of primary blow-expansion processing of primitive plastic film in lateral direction, in which the primitive plastic film that is extruded and initially molded in Step (a) is subjected to primary blow-expansion processing with the first blow-expanding mechanism so that the primitive plastic film is blown and expanded in the lateral direction to a volume of which an opening ratio is 1:1;
(c) a step of primary press-flattening and pull-stretching processing of primitive plastic film in longitudinal direction, in which the primitive plastic film that has been subjected to the primary blow-expansion processing in Step (b) is subjected to primary press-flattening and pull-stretching processing of the primitive plastic film in a longitudinal direction by at least one pair of front-stage press rollers and middle-stage press rollers;
(d) a step of secondary blow-expansion processing of primitive plastic film in lateral direction, in which the primitive plastic film that has been subjected to the primary press-flattening and pull-stretching processing in Step (c) is processed with a second blow-expansion mechanism to subject the primitive plastic film that has been subjected to primary longitudinal press-flattening and pull-stretching to heating and secondary blow-expanding at a temperature of 160° C.-220° C. and a pressure of 1.1-1.6 atm to achieve a volume in which the primitive plastic film has an opening ratio of at least 2:1 in the lateral direction for being shaped and feed out as a shaped plastic film;
(e) a step of secondary press-flattening and pull-stretching processing of shaped plastic film in longitudinal direction, in which the shaped plastic film that has been subjected to secondary blow-expanding in Step (d) is processed with at least one pair of rear-stage press rollers to subject the plastic film to secondary press-flattening and pull-stretching in the longitudinal direction; and
(f) a step of out-feeding plastic packaging film product, in which the shaped plastic film that has been subjected to secondary press-flattening and pull-stretching in Step (e) becomes and is fed out as a plastic packaging film product that has been blown and expanded, and pulled and stretched to show homogeneous stress and quality in both lateral direction and longitudinal direction.

3. The method for blowing and stretching a plastic packaging film according to claim 2, wherein the primitive plastic film of Step (a) is made of a material of PVC and the second blow-expansion mechanism of Step (d) is operable at a temperature of 165° C.-195° C. and a pressure of 1.1-1.6 atm.

4. The method for blowing and stretching a plastic packaging film according to claim 2, wherein the primitive plastic film of Step (a) is made of a material of PLA and the second blow-expansion mechanism of Step (d) is operable at a temperature of 160° C.-185° C. and a pressure of 1.1-1.6 atm.

5. The method for blowing and stretching a plastic packaging film according to claim 2, wherein the primitive plastic film of Step (a) is made of a material of PET and the second blow-expansion mechanism of Step (d) is operable at a temperature of 180° C.-220° C. and a pressure of 1.1-1.6 atm.

6. The method for blowing and stretching a plastic packaging film according to claim 2, wherein a rotational speed among the front-stage press rollers and the middle-stage press rollers of step (c) and the rear-stage press rollers of step (e) is between 30%-80%.

7. The method for blowing and stretching a plastic packaging film according to claim 2, wherein in Step (d), the second blow-expansion mechanism carries out heating of the primitive plastic film at a temperature of 160° C.-220° C. and then reducing the temperature by 10° C.-20° C. to achieve shape fixing of the primitive plastic film, followed by the secondary blow-expanding by supplying a pressure of 1.1-1.6 atm into the primitive plastic film.

8. The method for blowing and stretching a plastic packaging film according to claim 2, wherein the second blow-expansion mechanism of step (d) comprises:
at least one heating-extension oven, which is arranged at a location that is on an upper side of the second blow-expansion mechanism and below the middle-stage press rollers so that the heating-extension oven subjects the primitive plastic film that has been subjected to the primary press-flattening and pull-stretching by the middle-stage press rollers to heating to a temperature of 160° C.-220° C.;
at least one annular water tank, which is arranged below the heating-extension oven and is filled, in an interior thereof, with water having a temperature of 10° C.-20° C. for shaping the primitive plastic film that has been heated by the heating-extension oven; and
at least one movable air charging device, which is arranged below the annular water tank and comprises at least one movable air charging nozzle and an air charger, the movable air charging nozzle being connected to the air charger, the movable air charging nozzle being extendable into an interior of the primitive plastic film that has been shaped by the annular water tank in order to supply a pressure of 1.1-1.6 atm into the interior of the primitive plastic film to subject the primitive plastic film that has been subjected to primary longitudinal press-flattening and pull-stretching to heating and blow-expanding to achieve a volume in which the primitive plastic film has a lateral opening ratio of at least 2:1 to shape and out feed a shaped plastic film.
